(19) United States
(12) Patent Application Publication
(10) Pub. No.: US 2025/0373440 A1
(43) Pub. Date: Dec. 4, 2025

(54) METHOD, COMMUNICATION DEVICE AND STORAGE MEDIUM FOR AUTHENTICATING AND AUTHORIZING

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/874,972

(22) PCT Filed: Jun. 17, 2022
(86) PCT No.: PCT/CN2022/099636

§ 371 Date: Dec. 13, 2024

(51) Int. Cl. H04L 9/32; G06F 9/4401; H04L 9/08

(52) U.S. Cl. CPC H04L 9/3247; G06F 9/4401; H04L 9/0861; H04L 9/3234

(57) ABSTRACT

Provided in the embodiments of the present disclosure is a method for authenticating and authorizing. The method is performed by an edge enabler client (EEC). The method includes: sending authentication and authorization information to an edge enabler server (EES), wherein the authentication and authorization information is used for requesting the EES to authorize an EES service. Compared with the method of using an unauthorized process, the present disclosure can improve the security of an edge service.

### CROSS-REFERENCE TO RELATED APPLICATION

The present application is a U.S. National Phase of International Patent Application No. PCT/CN2022//099636 filed on Jun. 17, 2022. The contents of the above-cited application are hereby incorporated by reference for all purposes.

### BACKGROUND OF THE INVENTION

In the radio communication technology, how to authenticate and authorize an edge enabler client (EEC) hosted in a roaming terminal to visit an edge computation service available in a visited public land mobile network (VPLMN) has to be determined. A roaming user needs to be authorized by a home location carrier and a visit location carrier before visiting an edge application in the network.

### SUMMARY OF THE INVENTION

Examples of the disclosure disclose a method, apparatus, communication device and storage medium for authenticating and authorizing.

According to a first aspect of the examples of the disclosure, a method for authenticating and authorizing is provided. Where the method is performed by an edge enabler client (EEC). The method includes:
sending authentication and authorization information to an edge enabler server (EES); where
the authentication and authorization information is configured to request the EES to authorize an EES service.

According to a second aspect of the examples of the disclosure, a method for authenticating and authorizing is provided. Where the method is performed by an edge enabler server (EES). The method includes:
receiving authentication and authorization information transmitted by an edge enabler client (EEC); where
the authentication and authorization information is configured to request the EES to authorize an EES service.

According to a third aspect of the examples of the disclosure, a method for authenticating and authorizing is provided. Where the method is performed by a Zn interface proxy Zn-Proxy. The method includes:
receiving application request information transmitted by an EES; where
the application request information includes at least one of:
a B-TID of the EES;
a network application function (NAF) identifier (ID); or
a key type indicator.

According to a fourth aspect of the examples of the disclosure, a method for authenticating and authorizing is provided. Where the method is performed by a bootstrapping server function (BSF). The method includes:
receiving application request information transmitted by a Zn-Proxy; where
the application request information includes at least one of:
a B-TID of an EES;
a network application function (NAF) identifier (ID); or
a key type indicator.

According to a fifth aspect of the examples of the disclosure, a communication device is provided. The communication device includes:
a processor; and
a memory configured to store a processor-executable instruction; where
the processor is configured to implement the method according to any example of the disclosure when running the executable instruction.

According to a sixth aspect of the examples of the disclosure, a non-temporary computer storage medium is provided. The non-temporary computer storage medium stores a computer-executable program, where the executable program implements the method according to any example of the disclosure when executed by a processor.

### BRIEF DESCRIPTION OF DRAWINGS

FIG. 1 is a schematic structural diagram of a radio communication system according to an example.

FIG. 2 is a schematic flowchart of a method for authenticating and authorizing according to an example.

FIG. 3 is a schematic flowchart of another method for authenticating and authorizing according to an example.

FIG. 4 is a schematic flowchart of yet another method for authenticating and authorizing according to an example.

FIG. 5 is a schematic flowchart of yet another method for authenticating and authorizing according to an example.

FIG. 6 is a schematic flowchart of yet another method for authenticating and authorizing according to an example.

FIG. 7 is a schematic flowchart of yet another method for authenticating and authorizing according to an example.

FIG. 8 is a schematic flowchart of yet another method for authenticating and authorizing according to an example.

FIG. 9 is a schematic flowchart of yet another method for authenticating and authorizing according to an example.

FIG. 10 is a schematic flowchart of yet another method for authenticating and authorizing according to an example.

FIG. 11 is a schematic flowchart of yet another method for authenticating and authorizing according to an example.

FIG. 12 is a schematic flowchart of yet another method for authenticating and authorizing according to an example.

FIG. 13 is a schematic flowchart of yet another method for authenticating and authorizing according to an example.

FIG. 14 is a schematic flowchart of yet another method for authenticating and authorizing according to an example.

FIG. 15 is a schematic flowchart of yet another method for authenticating and authorizing according to an example.

FIG. 16 is a schematic flowchart of yet another method for authenticating and authorizing according to an example.

FIG. 17 is a schematic flowchart of yet another method for authenticating and authorizing according to an example.

FIG. 18 is a schematic flowchart of yet another method for authenticating and authorizing according to an example.

FIG. 19 is a schematic flowchart of yet another method for authenticating and authorizing according to an example.

FIG. 20 is a schematic flowchart of yet another method for authenticating and authorizing according to an example.

FIG. 21 is a schematic flowchart of yet another method for authenticating and authorizing according to an example.

FIG. 22 is a schematic flowchart of still another method for authenticating and authorizing according to an example.

FIG. 23 is a schematic structural diagram of an apparatus for authenticating and authorizing according to an example.

FIG. 24 is a schematic structural diagram of another apparatus for authenticating and authorizing according to an example.

FIG. 25 is a schematic structural diagram of yet another apparatus for authenticating and authorizing according to an example.

FIG. 26 is a schematic structural diagram of still another apparatus for authenticating and authorizing according to an example.

FIG. 27 is a schematic structural diagram of a terminal according to an example.

FIG. 28 is a block diagram of a base station according to an example.

### DETAILED DESCRIPTION OF THE INVENTION

Examples will be described in detail here, and their instances are shown in the accompanying drawings. When the following description involves the accompanying drawings, the same numerals in different accompanying drawings indicate the same or similar elements unless otherwise indicated. Embodiments described in the following examples do not denote all embodiments consistent with the examples of the disclosure. On the contrary, these embodiments are merely instances of apparatuses and methods consistent with some aspects of the examples of the disclosure as detailed in the appended claims.

Terms used in the examples of the disclosure are merely used for describing specific examples rather than limiting the examples of the disclosure. Singular forms such as “a”, “an”, “the” and “this” used in examples of the disclosure and the appended claims are also intended to include plural forms, unless otherwise clearly stated in the context. It should also be understood that the term “and/or” used here indicates and includes any or all possible combinations of one or more of associated listed items.

It should be understood that although terms such as first, second and third can be used in the examples of the disclosure to describe different types of information, the information should not be limited to these terms. These terms are merely used for distinguishing the same type of information from each other. For example, first information can also be referred to as second information and the second information can also be referred to as the first information similarly without departing from the scope of examples of the disclosure. Depending on the context, the word “if” as used here can be interpreted as “at the time of” or “when” or “in response to determining”.

For purposes of concision and ease of understanding, the term “greater than” or “less than” is used here to represent a size relation. Those skilled in that art can understand that the term “greater than” also covers the meaning of “greater than or equal to”, and the term “less than” also covers the meaning of “less than or equal to”.

The disclosure relates to, but is not limited to, the technical field of wireless communication, in particular to a method, apparatus, communication device and storage medium for authenticating and authorizing.

With reference to FIG. 1, a schematic structural diagram of a radio communication system according to an example of the disclosure is shown. As shown in FIG. 1, the radio communication system is a communication system based on mobile communication technology. The radio communication system may include several pieces of user equipment 110 and several base stations 120.

The user equipment 110 may be a device that provides voice and/or data connectivity for a user. The user equipment 110 may communicate with one or more core networks via a radio access network (RAN). The user equipment 110 may be Internet of Things user equipment, such as a sensor device, a mobile phone and a computer with the Internet of Things user equipment. For example, the user equipment may be a fixed, portable, pocket-type, handheld, computer built-in or vehicle-mounted device. For example, the user equipment may be a station (STA), a subscriber unit, a subscriber station, a mobile station, a mobile, a remote station, an access point, a remote terminal, an access terminal, a user terminal, a user agent, a user device or user equipment (UE). Alternatively, the user equipment 110 may also be a device of an unmanned aerial vehicle. Alternatively, the user equipment 110 may be a vehicle-mounted device, for example, an electronic control unit having a radio communication function, or radio user equipment externally connected to the electronic control unit. Alternatively, the user equipment 110 may also be a roadside device, such as a street lamp, a signal lamp or other roadside devices having a radio communication function.

The base station 120 may be a network-side device in a radio communication system. The radio communication system may be the 4^{th} generation mobile communication (4G) system, also referred to as a long term evolution (LTE) system, or the radio communication system may be a 5G system, also referred to as a new radio system or a 5G NR system. Alternatively, the radio communication system may be a next generation system after the 5G system. An access network in the 5G system may be referred to as a new generation-radio access network (NG-RAN).

The base station 120 may be an evolved base station (eNB) used in the 4G system. Alternatively, the base station 120 may be a base station (gNB) adopting a central distributed architecture in the 5G system. When adopting the centralized distributed architecture, the base station 120 usually includes a central unit (CU) and at least two distributed units (DUs). Protocol stacks of a packet data convergence protocol (PDCP) layer, a radio link control (RLC) layer and a media access control (MAC) layer are arranged in the central unit. A physical (PHY) layer protocol stack is arranged in the distributed unit. A specific implementation of the base station 120 is not limited in the example of the disclosure.

A radio connection may be established between the base station 120 and the user equipment 110 through radio. In different embodiments, the radio is radio based on the fourth generation mobile communication network technology (4G) standard, or the radio is radio based on the fifth generation mobile communication network technology (5G) standard, for example, the radio is new radio, or the radio may also be radio based on the next generation mobile communication network technology standard after 5G.

In some examples, an end to end (E2E) connection may also be established between the user equipment 110, for example, vehicle to vehicle (V2V) communication, vehicle to infrastructure (V2I) communication and vehicle to pedestrian (V2P) communication in vehicle to everything (V2X).

Here, the user equipment described above may be considered as a terminal device in the following example.

In some examples, the radio communication system above may further include a network management device 130.

Several base stations 120 are separately connected to the network management device 130. The network management device 130 may be a core network device in the radio communication system, for example, the network management device 130 may be a mobility management entity (MME) in an evolved packet core network (EPC). Alternatively, the network management device may be other core network devices, such as a serving gateway (SGW), a public data network gateway (PGW), a policy and charging rules function (PCRF) or a home subscriber server (HSS). An implementation form of the network management device 130 is not limited in the example of the disclosure.

For the convenience of understanding by those skilled in the art, the technical solutions of the examples of the disclosure are clearly described by enumerating a plurality of embodiments in the examples of the disclosure. It is clear that those skilled in the art can understand that a plurality of examples provided by the examples of the disclosure can be executed separately, or can be executed in combination with the methods of the other examples of the disclosure, or can be further executed separately or in combination with some methods in other related arts, which is not limited in the example of the disclosure.

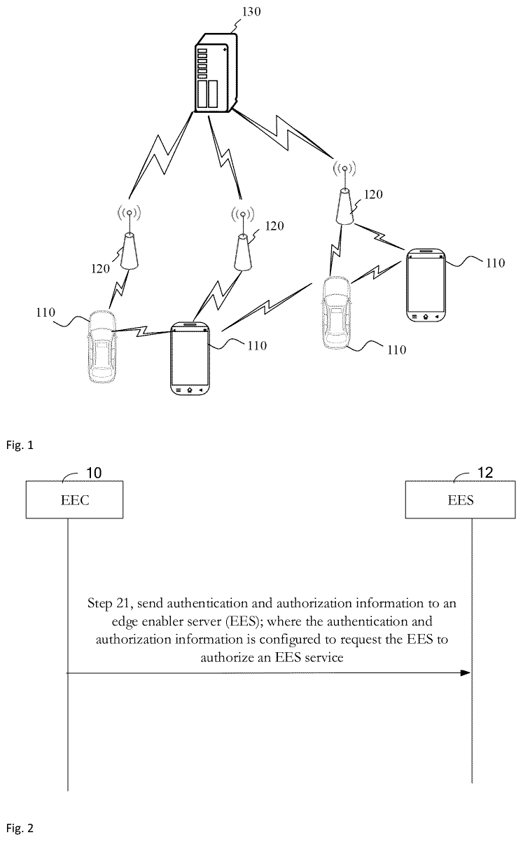

In the related art, an edge enabler server (EES) cannot authenticate and authorize the EEC in a roaming scenario. In view of this, As shown in FIG. 2, a method for authenticating and authorizing is provided by this example. The method is performed by an edge enabler client (EEC) 10. The method includes:

Step 21, authentication and authorization information is sent to an edge enabler server (EES) 12.

The authentication and authorization information is configured to request the EES to authorize an EES service.

Here, a terminal involved in the disclosure may be, but is not limited to, a mobile phone, a wearable device, a vehicle-mounted terminal, a road side unit (RSU), a smart home terminal, an industrial sensing device and/or a medical device. In some examples, the terminal may be a Redcap terminal or a new radio (NR) terminal of a predetermined version (for example, an NR terminal of R17). The terminal may register in a home network. The terminal may obtain a bootstrapping transaction identifier (B-TID) from a bootstrapping server function (BSF) of the home network of the EEC during running of a generic bootstrapping architecture (GBA). By treating the EES as a network application function (NAF), different types of keys, for example, Ks_NAF, Ks_int_NAF and Ks_ext_NAF, may be computed according to an NAF identifier (ID) of the EES. The terminal may select one of the keys as K_{EES}. In an example, the terminal may derive K_{EEC-EES} from K_{EES} and an EEC ID. The K_{EEC-EES} may be derived by using a key derivation function (KDF). The EEC ID is used as an input parameter of the KDF and the K_{EES} is used as a key for deriving the K_{EEC-EES}.

Here, the edge enabler client (EEC) may be an application, such as WeChat application and Weibo application, run on the terminal.

It should be noted that in the example of the disclosure, the EES is deployed in an operator domain and trusted by the operator. The EES obtains a certificate or a public key of the ECS. The EES and the ECS may communicate with each other wirelessly based on a radio communication network. The radio communication network may be, but is not limited to, a 4G or 5G radio communication network, and may also be other evolved radio communication networks, which is not limited here.

In the example of the disclosure, the edge enabler client (EEC) transmits the authentication and authorization information to the edge enabler server (EES). The authentication and authorization information is configured to request the EES to authorize the EES service. Here, since the authentication and authorization information carries information for requesting the EES to authorize the EES service, the EES can authorize the EES service or reject the EES service for the EEC after receiving the authentication and authorization information. Thus, security of an edge service can be improved compared with a method of adopting an unauthorized process.

In an example, the authentication and authorization information may be registration request information for registration.

In an example, the authentication and authorization information is transmitted to the edge enabler server (EES). The authentication and authorization information is configured to request the EES to authorize the EES service. The authentication and authorization information includes at least one of:
a bootstrapping transaction identifier (B-TID);
an encrypted EEC identifier (ID), where the encrypted EEC ID is encrypted based on a key K_{EES};
a key type indicator; where the key type indicator may be a character string, for example, Ks_int_NAF, and is used as a key of the K_{EES};
a generic public subscription identifier (GPSI);
a message authentication code MAC-I; or
a service token.

It should be noted that the message authentication code MAC-I is configured to protect integrity of at least one of: the B-TID, the encrypted EEC ID, the GPSI, the key type indicator, and the service token provided by the EES. It should be noted that the message authentication code MAC-I is generated based on a protected message and the K_{EES}.

It should be noted that if the EES authorizes the EEC to access the EES through the service token, the ECC may transmit the service token to the EES through the authentication and authorization information.

In an example, the EEC may obtain the B-TID from the bootstrapping server function (BSF) of the home network of the EEC during the running of the generic bootstrapping architecture (GBA).

In an example, the authentication and authorization information is transmitted to the edge enabler server (EES). The authentication and authorization information is configured to request the EES to authorize the EES service. Authentication and authorization response information transmitted, for the authentication and authorization information, by the EES is received. The authentication and authorization response information indicates that the EES authorizes the EES service requested by the EEC or rejects the EES service requested by the EEC.

In an example, the key K_{EEC-EES} is determined based on the key K_{EES} and the EEC identifier (ID). Mutual identity authentication and/or establishment of a transport layer security (TLS) connection are/is executed between the EEC and the EES based on the key K_{EEC-EES}.

In the example of the disclosure, the edge enabler client (EEC) transmits the authentication and authorization information to the edge enabler server (EES). The authentication and authorization information is configured to request the EES to authorize the EES service. Here, since the authentication and authorization information carries information for requesting the EES to authorize the EES service, the EES can authorize the EES service or reject the EES service for the EEC after receiving the authentication and authorization information. Thus, security of an edge service can be improved compared with a method of adopting an unauthorized process.

It should be noted that those skilled in the art can understand that the method according to the example of the disclosure can be executed separately, or can be executed together with some methods in the examples of the disclosure or some methods in the related art.

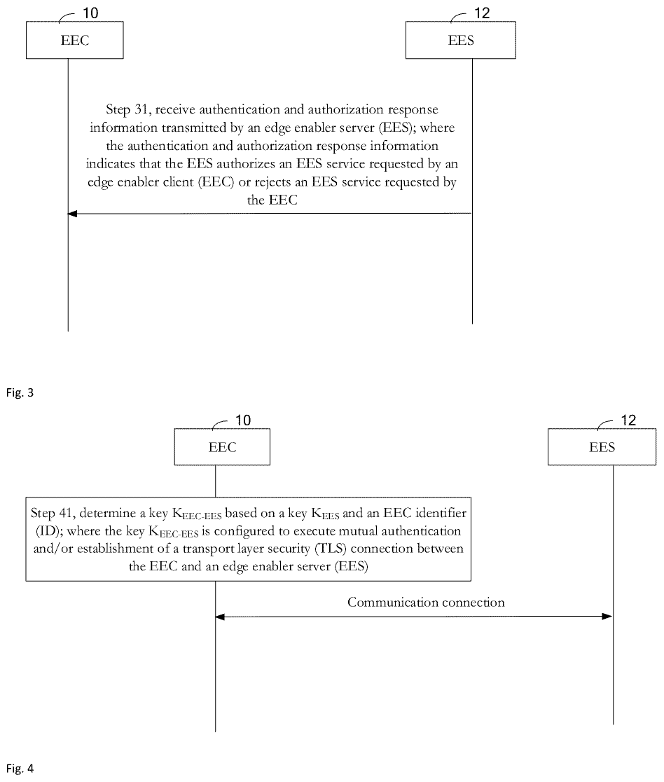

As shown in FIG. 3, another method for authenticating and authorizing is provided by this example. The method is performed by an edge enabler client (EEC) 10. The method includes:

Step 31, authentication and authorization response information sent by an EES 12 is received.

The authentication and authorization response information indicates that the EES authorizes an EES service requested by the EEC or rejects an EES service requested by the EEC.

In an example, authentication and authorization information is transmitted to the edge enabler server (EES). The authentication and authorization information is configured to request the EES to authorize the EES service. The authentication and authorization response information transmitted, for the authentication and authorization information, by the EES is received. The authentication and authorization response information indicates that the EES authorizes the EES service requested by the EEC or rejects the EES service requested by the EEC.

In an example, in response to determining that the EES authorizes the EES service requested by the EEC, the EES service can be obtained. Alternatively, in response to determining that the EES rejects the EES service requested by the EEC, the EES service cannot be obtained.

In an example, the authentication and authorization information is transmitted to the edge enabler server (EES). The authentication and authorization information is configured to request the EES to authorize the EES service. The authentication and authorization information includes at least one of:
a bootstrapping transaction identifier (B-TID);
an encrypted EEC identifier (ID), where the encrypted EEC ID is encrypted based on a key K_{EES};
a key type indicator; where the key type indicator may be a character string, for example, Ks_int_NAF, and is used as a key of the K_{EES};
a generic public subscription identifier (GPSI);
a message authentication code MAC-I; or
a service token.

It should be noted that the message authentication code MAC-I is configured to protect integrity of at least one of: the B-TID, the encrypted EEC ID, the GPSI, the key type indicator, or the service token provided by the EES.

It should be noted that if the EES authorizes the EEC to access the EES through the service token, the ECC may transmit the service token to the EES through the authentication and authorization information.

In an example, the EEC may obtain the B-TID from a bootstrapping server function (BSF) of a home network of the EEC during running of a generic bootstrapping architecture (GBA).

In an example, a key K_{EEC-EES} is determined based on the key K_{EES} and the EEC identifier (ID). Mutual identity authentication and/or establishment of a transport layer security (TLS) connection are/is executed between the EEC and the EES based on the key K_{EEC-EES}.

It should be noted that those skilled in the art can understand that the method according to the example of the disclosure can be executed separately, or can be executed together with some methods in the examples of the disclosure or some methods in the related art.

As shown in FIG. 4, yet another method for authenticating and authorizing is provided by this example. The method is performed by an edge enabler client (EEC) 10. The method includes:

Step 41, a key K_{EEC-EES} is determined based on a key K_{EES} and an EEC identifier (ID).

The key K_{EEC-EES} is configured to execute mutual identity authentication and/or establishment of a transport layer security (TLS) connection between the EEC and an edge enabler server (EES) 12.

In an example, different types of keys, for example, Ks_NAF, Ks_int_NAF and Ks_ext_NAF, may be computed according to a network application function identifier (NAF ID) of the EES. A terminal may select one of the keys as the K_{EES}.

In an example, the key K_{EEC-EES} is determined based on the key K_{EES} and the EEC identifier (ID). The mutual identity authentication and/or the establishment of the transport layer security (TLS) connection are/is executed between the EEC and the EES based on the key K_{EEC-EES}.

It should be noted that those skilled in the art can understand that the method according to the example of the disclosure can be executed separately, or can be executed together with some methods in the examples of the disclosure or some methods in the related art.

As shown in FIG. 5, yet another method for authenticating and authorizing is provided by this example. The method is performed by an edge enabler client (EEC) 10. The method includes:

Step 51, mutual identity authentication and/or establishment of a transport layer security (TLS) connection are/is executed between the EEC and an edge enabler server (EES) 12 based on a key K_{EEC-EES}.

In an example, different types of keys, for example, Ks_NAF, Ks_int_NAF and Ks_ext_NAF, may be computed according to a network application function identifier (NAF ID) of the EES. A terminal may select one of the keys as the K_{EES}. The key K_{EEC-EES} is determined based on the key K_{EES} and an EEC identifier (ID). The mutual identity authentication and/or the establishment of the transport layer security (TLS) connection are/is executed between the EEC and the EES based on the key K_{EEC-EES}.

It should be noted that those skilled in the art can understand that the method according to the example of the disclosure can be executed separately, or can be executed together with some methods in the examples of the disclosure or some methods in the related art.

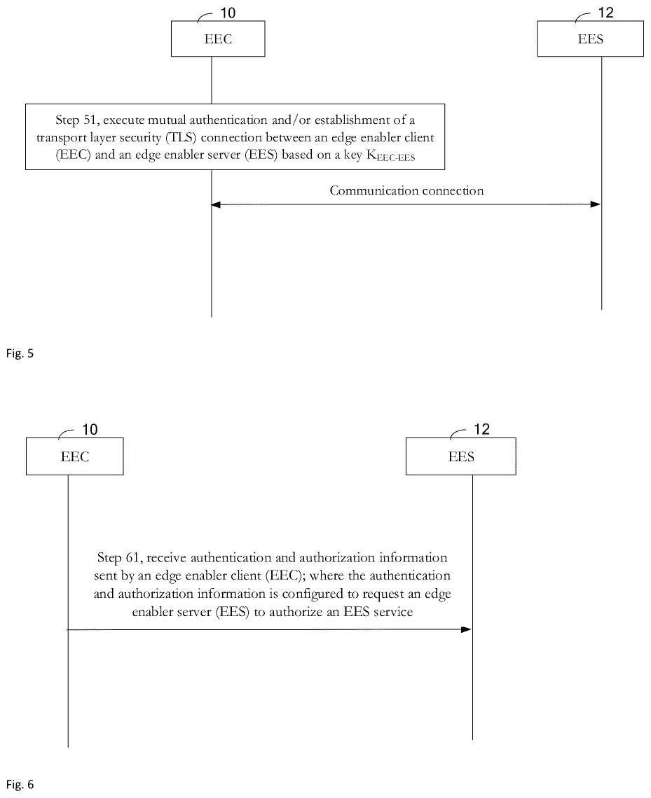

As shown in FIG. 6, yet another method for authenticating and authorizing is provided by this example. The method is performed by an edge enabler server (EES) 12. The method includes:

Step 61, authentication and authorization information transmitted by an edge enabler client (EEC) 10 is received.

The authentication and authorization information is configured to request the EES to authorize an EES service.

Here, a terminal involved in the disclosure may be, but is not limited to, a mobile phone, a wearable device, a vehicle-mounted terminal, a road side unit (RSU), a smart home terminal, an industrial sensing device and/or a medical device. In some examples, the terminal may be a Redcap terminal or a new radio (NR) terminal of a predetermined version (for example, an NR terminal of R17). The terminal may register in a home network. The terminal may obtain a bootstrapping transaction identifier (B-TID) from a bootstrapping server function (BSF) of the home network of the EEC during running of a generic bootstrapping architecture (GBA). By treating the EES as a network application function (NAF), different types of keys, for example, Ks_NAF, Ks_int_NAF and Ks_ext_NAF, may be computed according to an NAF identifier (ID) of the EES. The terminal may select one of the keys as the K_{EES}. In an example, the terminal may derive K_{EEC-EES} from K_{EES} and an EEC ID. The K_{EEC-EES} may be derived by using a key derivation function (KDF). The EEC ID is used as an input parameter of the KDF and the K_{EES} is used as a key for deriving the K_{EEC-EES}.

Here, the edge enabler client (EEC) may be an application, such as WeChat application and Weibo application, run on the terminal.

It should be noted that in the example of the disclosure, the EES is deployed in an operator domain and trusted by the operator. The EES obtains a certificate or a public key of the ECS. The EES and the ECS may communicate with each other wirelessly based on a radio communication network. The radio communication network may be, but is not limited to, a 4G or 5G radio communication network, and may also be other evolved radio communication networks, which is not limited here.

In the disclosure, the authentication and authorization information may be registration request information for registration.

In an example, the authentication and authorization information transmitted by the edge enabler client (EEC) is received. The authentication and authorization information is configured to request the EES to authorize the EES service. The authentication and authorization information includes at least one of:
a bootstrapping transaction identifier (B-TID);
an encrypted EEC identifier (ID), where the encrypted EEC ID is encrypted based on a key K_{EES};
a key type indicator; where the key type indicator may be a character string, for example, Ks_int_NAF, and is used as a key of the K_{EES};
a generic public subscription identifier (GPSI);
a message authentication code MAC-I; or
a service token.

It should be noted that the message authentication code MAC-I is configured to protect integrity of at least one of: the B-TID, the encrypted EEC ID, the GPSI, the key type indicator, or the service token provided by the EES.

It should be noted that if the EES authorizes the EEC to access the EES through the service token, the ECC may transmit the service token to the EES through the authentication and authorization information.

In an example, the EEC may obtain the B-TID from the bootstrapping server function (BSF) of the home network of the EEC during the running of the generic bootstrapping architecture (GBA).

In an example, the authentication and authorization information transmitted by the edge enabler client (EEC) is received. The authentication and authorization information is configured to request the EES to authorize the EES service. Authentication and authorization response information is transmitted to the EEC for the authentication and authorization information. The authentication and authorization response information indicates that the EES authorizes the EES service requested by the EEC or rejects the EES service requested by the EEC.

In an example, the authentication and authorization information transmitted by the edge enabler client (EEC) is received. The authentication and authorization information is configured to request the EES to authorize the EES service. In response to determining that the authentication and authorization information is received, a network to which the EES is connected is determined. In response to determining that an identifier of the network to which the EES is connected is identical to an identifier of a public land mobile network of the EEC that is configured to establish a connection to the EES, and the identifier of the public land mobile network of the EEC that is configured to establish a connection to the EES is different from a home network identifier of the EEC, a connection to the network to which the EES is connected is established.

In an example, the authentication and authorization information transmitted by the edge enabler client (EEC) is received. The authentication and authorization information is configured to request the EES to authorize the EES service. In response to determining that the authentication and authorization information is received, the network to which the EES is connected is determined. The identifier and/or an access type of the public land mobile network of the EEC that is configured to establish a connection to the EES are/is obtained from a policy control function (PCF). In response to determining that the identifier of the network to which the EES is connected is identical to the identifier of the public land mobile network of the EEC that is configured to establish a connection to the EES, and the identifier of the public land mobile network of the EEC that is configured to establish a connection to the EES is different from the home network identifier of the EEC, the connection to the network to which the EES is connected is established.

In an example, the authentication and authorization information transmitted by the edge enabler client (EEC) is received. The authentication and authorization information is configured to request the EES to authorize the EES service. In response to determining that the authentication and authorization information is received, the network to which the EES is connected is determined. The home network identifier of the EEC is determined based on a B-TID. In response to determining that the identifier of the network to which the EES is connected is identical to the identifier of the public land mobile network of the EEC that is configured to establish a connection to the EES, and the identifier of the public land mobile network of the EEC that is configured to establish a connection to the EES is different from the home network identifier of the EEC, the connection to the network to which the EES is connected is established.

In an example, the authentication and authorization information transmitted by the edge enabler client (EEC) is received. The authentication and authorization information is configured to request the EES to authorize the EES service. In response to determining that the authentication and authorization information is received, the network to which the EES is connected is determined. Application request information is transmitted to a proxy (Zn-Proxy) in the network of the EES. The application request information includes at least one of:
a B-TID of the EEC;
a network application function (NAF) identifier (ID) (NAF ID); or
a key type indicator.

In an example, the authentication and authorization information transmitted by the edge enabler client (EEC) is received. The authentication and authorization information is configured to request the EES to authorize the EES service. In response to determining that the authentication and authorization information is received, the network to which the EES is connected is determined. The application request information is transmitted to the proxy (Zn-Proxy) in the network of the EES. Application response information transmitted by the Zn-Proxy is received. The application response information includes the key K_{EES} and/or effective time information of the key K_{EES}. Integrity of authentication and authorization information is verified based on the key K_{EES} and/or the MAC-I.

In an example, the application response information transmitted by the Zn-Proxy is received. The application response information includes the key K_{EES} and/or the effective time information of the key K_{EES}. The integrity of the authentication and authorization information is verified based on the key K_{EES} and/or the MAC-I. In response to determining that the authentication and authorization information is modified, a request process is terminated. Alternatively, in response to determining that the authentication and authorization information is not modified, the encrypted EEC ID received by the EES is decrypted.

In an example, the application response information transmitted by the Zn-Proxy is received. The application response information includes the key K_{EES} and/or the effective time information of the key K_{EES}. In response to determining that the key K_{EES} is received, the key K_{EEC-EES} is determined based on the key K_{EES} and the EEC ID. Authentication of the EEC ID and/or establishment of a transport layer security (TLS) connection is executed between the EEC and the EES based on the key K_{EEC-EES}.

In an example, the authentication and authorization information transmitted by the edge enabler client (EEC) is received. The authentication and authorization information is configured to request the EES to authorize the EES service. The application response information transmitted by the Zn-Proxy is received. The application response information includes the key K_{EES} and/or the effective time information of the key K_{EES}. In response to determining that the key K_{EES} is received, the key K_{EEC-EES} is determined based on the key K_{EES} and the EEC ID. Authentication of the EEC ID and/or establishment of the TLS connection between the EEC and the EES are/is executed based on the key K_{EEC-EES}. An EES service authorization operation is executed between the EES and the EEC based on a pre-configured policy and/or a service token provided by the EEC.

In an example, the service token includes at least one of:
a fully qualified domain name (FQDN) of an edge configuration server (ECS);
the EEC identifier (ID);
a GPSI;
an expected EES service name;
an FQDN of the EES;
effective time; or
a digital signature.

In an example, the authentication and authorization information transmitted by the edge enabler client (EEC) is received. The authentication and authorization information is configured to request the EES to authorize the EES service. The application response information transmitted by the Zn-Proxy is received. The application response information includes the key K_{EES} and/or the effective time information of the key K_{EES}. In response to determining that the key K_{EES} is received, the key K_{EEC-EES} is determined based on the key K_{EES} and the EEC ID. Authentication of the EEC ID and/or establishment of the TLS connection between the EEC and the EES are/is executed based on the key K_{EEC-EES}. In response to determining that the registration authentication and authorization information matches the pre-configured policy, the EES service requested by the EEC is authorized.

In an example, the authentication and authorization information transmitted by the edge enabler client (EEC) is received. The authentication and authorization information is configured to request the EES to authorize the EES service. The application response information transmitted by the Zn-Proxy is received. The application response information includes the key K_{EES} and/or the effective time information of the key K_{EES}. In response to determining that the key K_{EES} is received, the key K_{EEC-EES} is determined based on the key KEES and the EEC ID. Authentication of the EEC ID and/or establishment of the TLS connection between the EEC and the EES are/is executed based on the key K_{EEC-EES}. Whether the service token expires is checked. In response to determining that the service token does not expire, a digital signature of an ECS in the token is verified by using the public key or the certificate of the ECS. Alternatively, in response to determining that the server token expires, the authentication and authorization information is rejected.

In an example, the authentication and authorization information transmitted by the edge enabler client (EEC) is received. The authentication and authorization information is configured to request the EES to authorize the EES service. The application response information transmitted by the Zn-Proxy is received. The application response information includes the key K_{EES} and/or the effective time information of the key K_{EES}. In response to determining that the key K_{EES} is received, the key K_{EEC-EES} is determined based on the key K_{EES} and the EEC ID. Authentication of the EEC ID and/or establishment of the TLS connection between the EEC and the EES are/is executed based on the key K_{EEC-EES}. Whether the service token expires is checked. In response to determining that the service token does not expire, the digital signature of the ECS in the token is verified by using the public key or the certificate of the ECS. Alternatively, in response to determining that the server token expires, the authentication and authorization information is rejected. In response to determining that the digital signature of the ECS passes verification, predetermined information is verified based on the service token. The predetermined information includes at least one of: the EEC ID, a GPSI and a requested EES service name. In response to determining that the service token matches the predetermined information, the EES service requested by the EEC is authorized.

It should be noted that those skilled in the art can understand that the method according to the example of the disclosure can be executed separately, or can be executed together with some methods in the examples of the disclosure or some methods in the related art.

As shown in FIG. 7, yet another method for authenticating and authorizing is provided by this example. The method is performed by an edge enabler server (EES) 12. The method includes:

Step 71, in response to determining that authentication and authorization information is received, a network to which the EES is connected is determined.

In an example, the authentication and authorization information transmitted by an edge enabler client (EEC) 10 is received. The authentication and authorization information is configured to request the EES to authorize an EES service. In response to determining that the authentication and authorization information is received, the network to which the EES is connected is determined. In response to determining that an identifier of the network to which the EES is connected is identical to an identifier of a public land mobile network of the EEC that is configured to establish a connection to the EES, and the identifier of the public land mobile network of the EEC that is configured to establish a connection to the EES is different from a home network identifier of the EEC, a connection to the network to which the EES is connected is established.

In an example, the authentication and authorization information transmitted by the edge enabler client (EEC) is received. The authentication and authorization information is configured to request the EES to authorize the EES service. In response to determining that the authentication and authorization information is received, the network to which the EES is connected is determined. The identifier and/or an access type of the public land mobile network of the EEC that is configured to establish a connection to the EES are/is obtained from a policy control function (PCF). In response to determining that the identifier of the network to which the EES is connected is identical to the identifier of the public land mobile network of the EEC that is configured to establish a connection to the EES, and the identifier of the public land mobile network of the EEC that is configured to establish a connection to the EES is different from the home network identifier of the EEC, the connection to the network to which the EES is connected is established.

In an example, the authentication and authorization information transmitted by the edge enabler client (EEC) is received. The authentication and authorization information is configured to request the EES to authorize the EES service. In response to determining that the authentication and authorization information is received, the network to which the EES is connected is determined. The home network identifier of the EEC is determined based on a B-TID. In response to determining that the identifier of the network to which the EES is connected is identical to the identifier of the public land mobile network of the EEC that is configured to establish a connection to the EES, and the identifier of the public land mobile network of the EEC that is configured to establish a connection to the EES is different from the home network identifier of the EEC, the connection to the network to which the EES is connected is established.

It should be noted that those skilled in the art can understand that the method according to the example of the disclosure can be executed separately, or can be executed together with some methods in the examples of the disclosure or some methods in the related art.

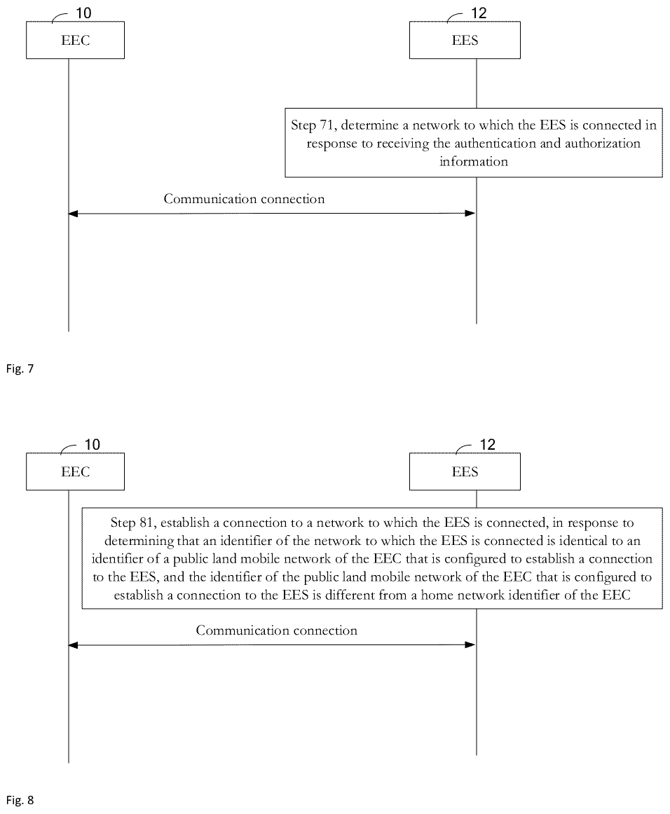

As shown in FIG. 8, yet another method for authenticating and authorizing is provided by this example. The method is performed by an edge enabler server (EES) 12. The method includes:

Step 81, in response to determining that an identifier of a network to which the EES is connected is identical to an identifier of a public land mobile network of an edge enabler client (EEC) 10 that is configured to establish a connection to the EES, and the identifier of the public land mobile network of the EEC that is configured to establish a connection to the EES is different from a home network identifier of the EEC, a connection to the network to which the EES is connected is established.

Reference can be made to the description of step 71 for the description of step 81 specifically, which will not be repeated here.

It should be noted that those skilled in the art can understand that the method according to the example of the disclosure can be executed separately, or can be executed together with some methods in the examples of the disclosure or some methods in the related art.

As shown in FIG. 9, yet another method for authenticating and authorizing is provided by this example. The method is performed by an edge enabler server (EES) 12. The method includes:

Step 91, application request information is transmitted to a Zn-Proxy 14 in a network of the EES.

The application request information includes at least one of:
a B-TID of an EEC;
a network application function (NAF) identifier (ID) (NAF ID); or
a key type indicator.

In an example, authentication and authorization information transmitted by the edge enabler client (EEC) is received. The authentication and authorization information is configured to request the EES to authorize an EES service. In response to determining that the authentication and authorization information is received, a network to which the EES is connected is determined. The application request information is transmitted to a proxy (Zn-Proxy) in the network of the EES. Application response information transmitted by the Zn-Proxy is received. The application response information includes a key K_{EES} and/or effective time information of the key K_{EES}.

It should be noted that those skilled in the art can understand that the method according to the example of the disclosure can be executed separately, or can be executed together with some methods in the examples of the disclosure or some methods in the related art.

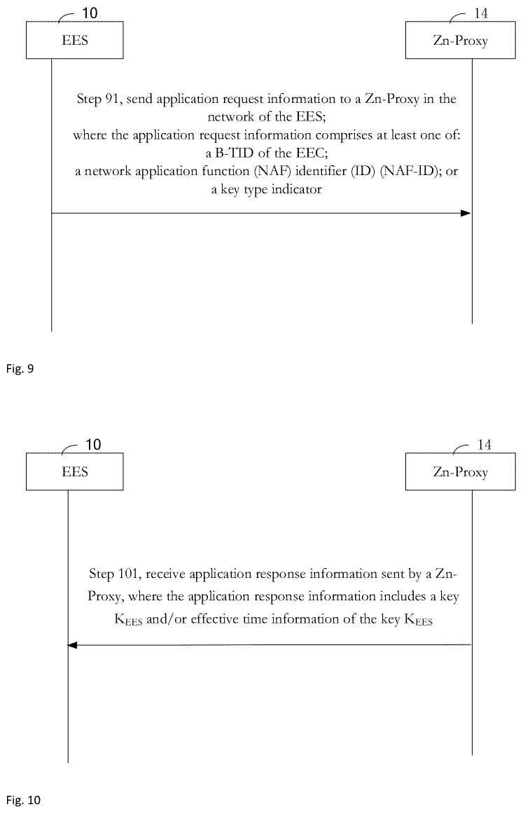

As shown in FIG. 10, yet another method for authenticating and authorizing is provided by this example. The method is performed by an edge enabler server (EES) 12. The method includes:

Step 101, application response information is transmitted to a Zn-Proxy 14. The application response information includes a key K_{EES} and/or effective time information of the key K_{EES}.

In an example, authentication and authorization information transmitted by an edge enabler client (EEC) is received. The authentication and authorization information is configured to request the EES to authorize an EES service. In response to determining that the authentication and authorization information is received, a network to which the EES is connected is determined. Application request information is transmitted to a proxy (Zn-Proxy) in the network of the EES. The application response information transmitted by the Zn-Proxy is received. The application response information includes a key K_{EES} and/or effective time information of the key K_{EES}.

The authentication and authorization information includes at least one of:
a B-TID of the EEC;
a network application function (NAF) identifier (ID) (NAF ID); or
a key type indicator.

It should be noted that those skilled in the art can understand that the method according to the example of the disclosure can be executed separately, or can be executed together with some methods in the examples of the disclosure or some methods in the related art.

As shown in FIG. 11, yet another method for authenticating and authorizing is provided by this example. The method is performed by an edge enabler server (EES) 12. The method includes:

Step 110, integrity of authentication and authorization information is verified based on a key K_{EES} and/or an MAC-I.

In an example, the authentication and authorization information transmitted by an edge enabler client (EEC) 10 is received. The authentication and authorization information is configured to request the EES to authorize an EES service. In response to determining that the authentication and authorization information is received, a network to which the EES is connected is determined. Application request information is transmitted to a proxy (Zn-Proxy) in the network of the EES. The application response information transmitted by the Zn-Proxy is received. The application response information includes the key K_{EES} and/or effective time information of the key K_{EES}. Integrity of the authentication and authorization information is verified based on the key K_{EES} and/or the MAC-I.

The application request information includes at least one of:
a B-TID of the EEC;
a network application function (NAF) identifier (ID) (NAF ID); or
a key type indicator.

It should be noted that those skilled in the art can understand that the method according to the example of the disclosure can be executed separately, or can be executed together with some methods in the examples of the disclosure or some methods in the related art.

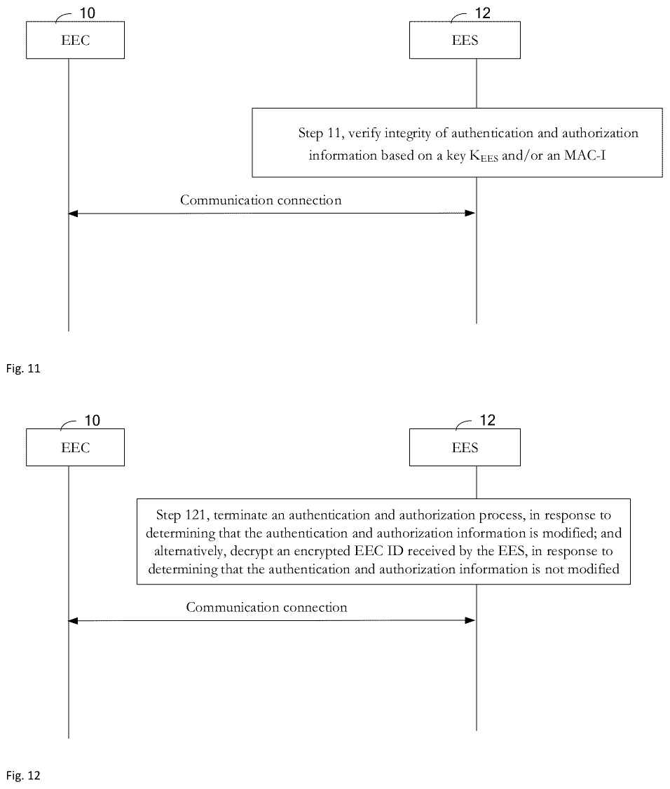

As shown in FIG. 12, yet another method for authenticating and authorizing is provided by this example. The method is performed by an edge enabler server (EES) 12. The method includes:

Step 121, in response to determining that authentication and authorization information is modified, a request process is terminated.

Alternatively,
in response to determining that authentication and authorization information is not modified, an encrypted edge enabler client (EEC) identifier (ID) received by the EES is decrypted.

In an example, the authentication and authorization information transmitted by the edge enabler client (EEC) 10 is received. The authentication and authorization information is configured to request the EES to authorize an EES service. In response to determining that the authentication and authorization information is received, a network to which the EES is connected is determined. Application request information is transmitted to a proxy (Zn-Proxy) in the network of the EES. Application response information transmitted by the Zn-Proxy is received. The application response information includes a key K_{EES} and/or effective time information of the key K_{EES}. Integrity of the authentication and authorization information is verified based on the key K_{EES} and/or an MAC-I. In response to determining that the authentication and authorization information is modified, the request process is terminated. Alternatively, in response to determining that the authentication and authorization information is not modified, the encrypted EEC ID received by the EES is decrypted.

The authentication and authorization information includes at least one of:
a B-TID of the EEC;
a network application function (NAF) identifier (ID) (NAF ID); or
a key type indicator.

It should be noted that those skilled in the art can understand that the method according to the example of the disclosure can be executed separately, or can be executed together with some methods in the examples of the disclosure or some methods in the related art.

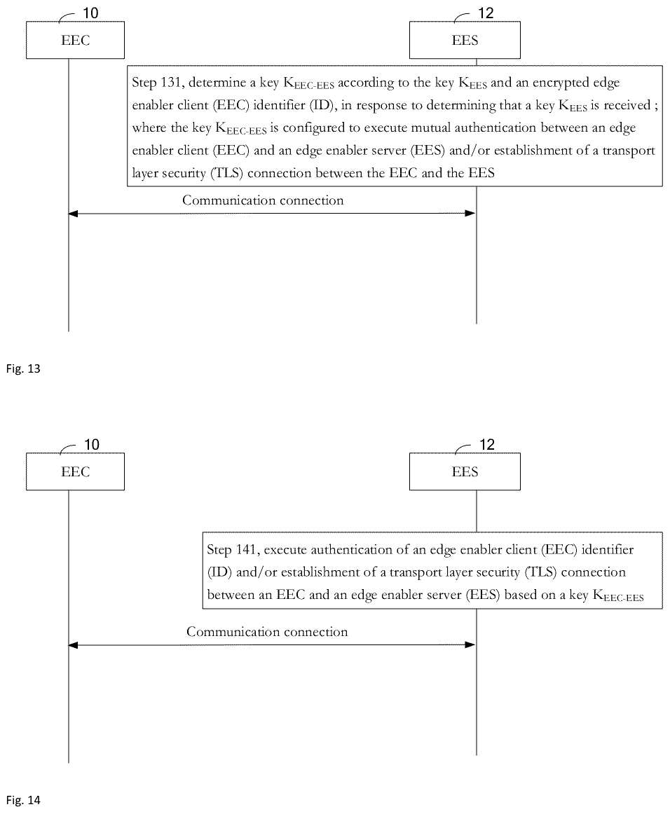

As shown in FIG. 13, yet another method for authenticating and authorizing is provided by this example. The method is performed by an edge enabler server (EES) 12. The method includes:

Step 131, in response to determining that a key K_{EES} is received, a key K_{EEC-EES} is determined according to the key K_{EES} and an EEC ID. The key K_{EEC-EES} is configured to execute mutual identity authentication between an EEC and the EES and/or establishment of a TLS connection between the EEC 10 and the EES 12.

In an example, application response information transmitted by a Zn-Proxy is received. The application response information includes the key K_{EES} and/or effective time information of the key K_{EES}. In response to determining that the key K_{EES} is received, the key K_{EEC-EES} is determined according to the key KEES and the EEC ID. The key K_{EEC-EES} is configured to execute the mutual authentication between the EEC and the EES and/or the establishment of the TLS connection between the EEC and the EES. Authentication of the EEC ID and/or establishment of the TLS connection between the EEC and the EES are/is executed based on the key K_{EEC-EES}.

It should be noted that those skilled in the art can understand that the method according to the example of the disclosure can be executed separately, or can be executed together with some methods in the examples of the disclosure or some methods in the related art.

As shown in FIG. 14, yet another method for authenticating and authorizing is provided by this example. The method is performed by an edge enabler server (EES) 12. The method includes:

Step 141, authentication of an EEC ID and/or establishment of a TLS connection are/is executed between an EEC 10 and the EES 12 based on the key K_{EEC-EES}.

Reference can be made to the description of step 131 for the description of step 141 specifically, which will not be repeated here.

It should be noted that those skilled in the art can understand that the method according to the example of the disclosure can be executed separately, or can be executed together with some methods in the examples of the disclosure or some methods in the related art.

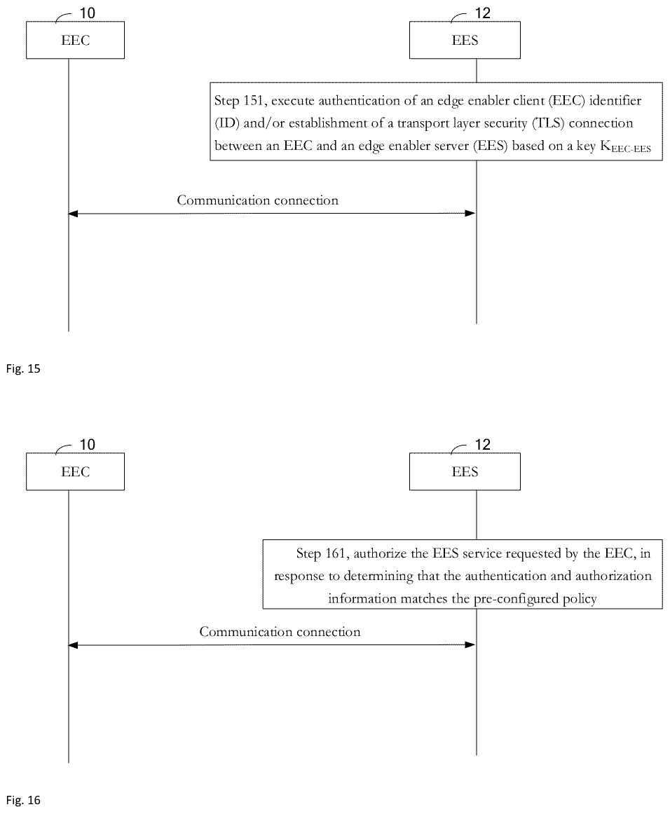

As shown in FIG. 15, yet another method for authenticating and authorizing is provided by this example. The method is performed by an edge enabler server (EES) 12. The method includes:

Step 151, authentication of an EEC ID and/or establishment of a TLS connection are/is executed between an EEC 10 and the EES 12 based on a key K_{EEC-EES}.

In an example, authentication and authorization information transmitted by the edge enabler client (EEC) is received. The authentication and authorization information is configured to request the EES to authorize an EES service. Application response information transmitted by a Zn-Proxy is received. The application response information includes a key K_{EES} and/or effective time information of the key K_{EES}. In response to determining that the key K_{EES} is received, the key K_{EEC-EES} is determined based on the key K_{EES} and the EEC ID. The authentication of the EEC ID and/or the establishment of the TLS connection are/is executed between the EEC and the EES based on the key K_{EEC-EES}. An EES service authorization operation is executed between the EES and the EEC based on a pre-configured policy and/or a service token provided by the EEC.

In an example, the service token includes at least one of:
a fully qualified domain name (FQDN) of an edge configuration server (ECS);
the EEC identifier (ID);
a GPSI;
an expected EES service name;
an FQDN of the EES;
effective time; or
a digital signature.

It should be noted that those skilled in the art can understand that the method according to the example of the disclosure can be executed separately, or can be executed together with some methods in the examples of the disclosure or some methods in the related art.

As shown in FIG. 16, yet another method for authenticating and authorizing is provided by this example. The method is performed by an edge enabler server (EES) 12. The method includes:

Step 161, in response to determining that authentication and authorization information matches pre-configured policy, an EES service requested by an EEC is authorized.

In an example, the authentication and authorization information transmitted by the edge enabler client (EEC) 10 is received. The authentication and authorization information is configured to request the EES to authorize the EES service. Application response information transmitted by a Zn-Proxy is received. The application response information includes a key K_{EES} and/or effective time information of the key K_{EES}. In response to determining that the key K_{EES} is received, a key K_{EEC-EES} is determined based on the key K_{EES} and an EEC ID. Authentication of the EEC ID and/or establishment of the TLS connection between the EEC and the EES are/is executed based on the key K_{EEC-EES}. In response to determining that the registration authentication and authorization information matches the pre-configured policy, the EES service requested by the EEC is authorized.

It should be noted that those skilled in the art can understand that the method according to the example of the disclosure can be executed separately, or can be executed together with some methods in the examples of the disclosure or some methods in the related art.

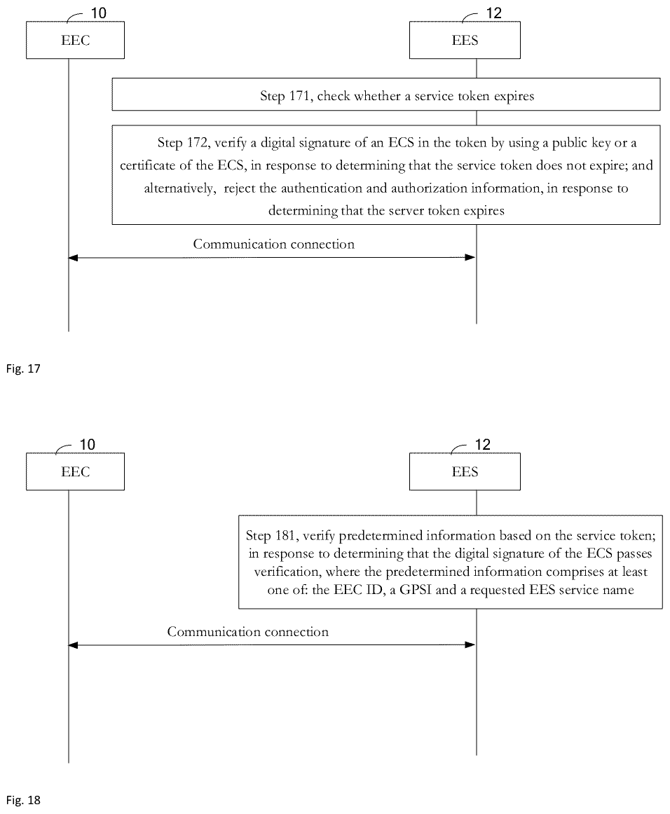

As shown in FIG. 17, yet another method for authenticating and authorizing is provided by this example. The method is performed by an edge enabler server (EES) 12. The method includes:

Step 171, whether a service token expires is checked.

Step 172, in response to determining that a service token does not expire, a digital signature of an ECS in the token is verified by using a public key or a certificate of the ECS. Alternatively, in response to determining that the server token expires, authentication and authorization information is rejected.

In an example, the authentication and authorization information transmitted by an edge enabler client (EEC) 10 is received. The authentication and authorization information is configured to request the EES to authorize an EES service. Application response information transmitted by a Zn-Proxy is received. The application response information includes a key K_{EES} and/or effective time information of the key K_{EES}. In response to determining that the key K_{EES} is received, a key K_{EEC-EES} is determined based on the key K_{EES} and an EEC ID. Authentication of the EEC ID and/or establishment of a TLS connection are/is executed between the EEC and the EES based on the key K_{EEC-EES}. Whether the service token expires is checked. In response to determining that the service token does not expire, the digital signature of the ECS in the token is verified by using the public key or the certificate of the ECS. Alternatively, in response to determining that the server token expires, the authentication and authorization information is rejected.

It should be noted that those skilled in the art can understand that the method according to the example of the disclosure can be executed separately, or can be executed together with some methods in the examples of the disclosure or some methods in the related art.

As shown in FIG. 18, yet another method for authenticating and authorizing is provided by this example. The method is performed by an edge enabler server (EES) 12. The method includes:

Step 181, in response to determining that a digital signature of an ECS passes verification, predetermined information is verified based on a service token. The predetermined information includes at least one of: an EEC ID, a GPSI or a requested EES service name.

In an example, authentication and authorization information transmitted by the edge enabler client (EEC) 12 is received. The authentication and authorization information is configured to request the EES to authorize an EES service. Application response information transmitted by a Zn-Proxy is received. The application response information includes a key K_{EES} and/or effective time information of the key K_{EES}. In response to determining that the key K_{EES} is received, a key K_{EEC-EES} is determined based on the key K_{EES} and an EEC ID. Authentication of the EEC ID and/or establishment of a TLS connection are/is executed between the EEC and the EES based on the key K_{EEC-EES}. Whether the service token expires is checked. In response to determining that the service token does not expire, the digital signature of the ECS in the token is verified by using a public key or a certificate of the ECS. Alternatively, in response to determining that the server token expires, the authentication and authorization information is rejected. In response to determining that the digital signature of the ECS passes verification, predetermined information is verified based on the service token. The predetermined information includes at least one of: the EEC ID, the GPSI or the requested EES service name. In response to determining that the service token matches the predetermined information, the EES service requested by the EEC is authorized.

It should be noted that those skilled in the art can understand that the method according to the example of the disclosure can be executed separately, or can be executed together with some methods in the examples of the disclosure or some methods in the related art.

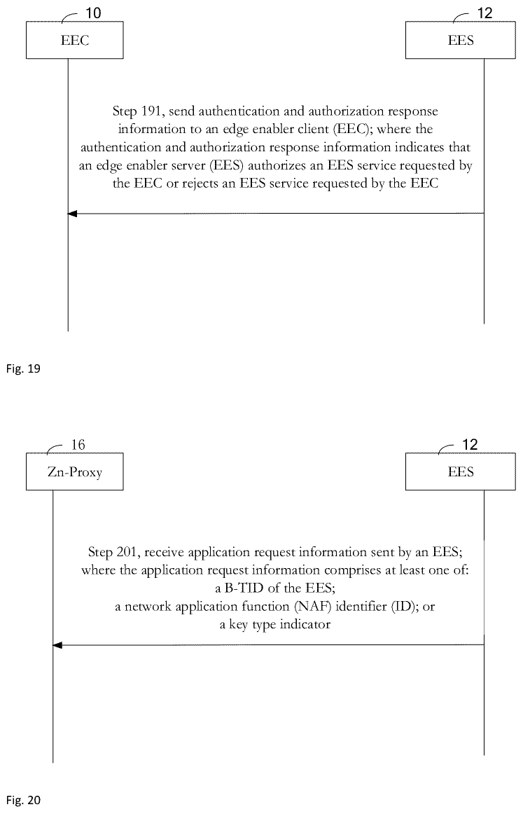

As shown in FIG. 19, yet another method for authenticating and authorizing is provided by this example. The method is performed by an edge enabler server (EES) 12. The method includes:

Step 191, authentication and authorization response information is transmitted to an EEC.

The authentication and authorization response information indicates that the EES authorizes an EES service requested by the EEC or rejects an EES service requested by the EEC.

In an example, authentication and authorization information transmitted by the edge enabler client (EEC) 10 is received. The authentication and authorization information is configured to request the EES to authorize the EES service. The authentication and authorization response information is transmitted to the EEC for the authentication and authorization information. The authentication and authorization response information indicates that the EES authorizes the EES service requested by the EEC or rejects the EES service requested by the EEC.

It should be noted that those skilled in the art can understand that the method according to the example of the disclosure can be executed separately, or can be executed together with some methods in the examples of the disclosure or some methods in the related art.

As shown in FIG. 20, yet another method for authenticating and authorizing is provided by this example. The method is performed by a Zn interface proxy Zn-Proxy 16. The method includes:

Step 201, application request information transmitted by an EES 12 is received.

The application request information includes at least one of:
a B-TID of the EES;
a network application function (NAF) identifier (ID); or
a key type indicator.

In an example, the application request information transmitted by the EES is

received. The application request information includes at least one of: the B-TID of the EES; the network application function (NAF) identifier (ID); or the key type indicator. The application request information is transmitted to a bootstrapping server function (BSF) in a home network of the EEC. Application response information transmitted by the BSF is received. The application response information includes a key K_{EES} and/or effective time information of the key K_{EES}. The application response information is transmitted to the EES. The application response information includes the key K_{EES} and/or the effective time information of the key K_{EES}.

It should be noted that those skilled in the art can understand that the method according to the example of the disclosure can be executed separately, or can be executed together with some methods in the examples of the disclosure or some methods in the related art.

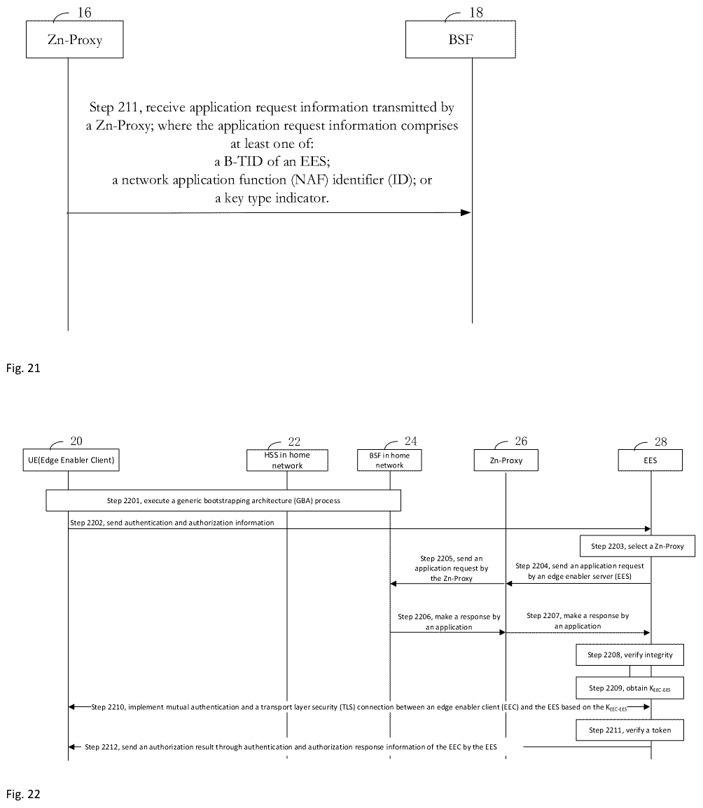

As shown in FIG. 21, yet another method for authenticating and authorizing is provided by this example. The method is performed by a bootstrapping server function (BSF) 18. The method includes:

Step 211, application request information transmitted by a Zn-Proxy 16 is received.

The application request information includes at least one of:
a B-TID of an EES;
a network application function (NAF) identifier (ID); or
a key type indicator.

In an example, the application request information transmitted by the Zn-Proxy is received. The application request information includes at least one of: the B-TID of the EES; the network application function (NAF) identifier (ID); or the key type indicator. A key K_{EES} is determined based on the application request information. Application response information is transmitted to the Zn-Proxy. The application response information includes the key K_{EES} and/or effective time information of the key K_{EES}.

It should be noted that those skilled in the art can understand that the method according to the example of the disclosure can be executed separately, or can be executed together with some methods in the examples of the disclosure or some methods in the related art.

In order to better understand the example of the disclosure, the technical solution of the disclosure will be further described through an example:

Instance 1:

With reference to FIG. 22, still another method for authenticating and authorizing according to this example includes:

Step 2201, a generic bootstrapping architecture (GBA) process is executed. UE registers in a home network. The UE 20 obtains a B-TID from a BSF 24 in a home network in the GBA process. By regarding an ECS as an NAF, Ks_NAF, Ks_int_NAF and Ks_ext_NAF may be computed by the UE according to a NAF ID of an EES. The UE selects one of the items as K_{EES}. The UE may derive K_{EEC-EES} from the K_{EES} and an EEC ID. The K_{EEC-EES} may be derived using a KDF defined in Appendix B of TS 33.220. The EEC ID is used as an input parameter and the K_{EES} is used as a key for deriving the K_{EEC-EES}.

The UE 20 sends an HTTP request to the BSF 24. When a TMPI associated with the IMPI in use is available on the UE 20, the UE 20 includes the TMPI in the “username” parameter, otherwise the UE 20 includes the IMPI.

The BSF 24 recognizes from the structure of the “username” parameter whether a TMPI or an IMPI was sent. If a TMPI was sent the BSF 24 looks up a corresponding IMPI in its local database. If the BSF 24 does not find an IMPI corresponding to the received TMPI, the BSF 24 returns an error message to the UE 20. The UE 20 deletes the TMPI and retries a request using the IMPI after receiving the error message.

The BSF 24 retrieves the complete set of GBA user security settings and a single authentication vector (AV) from HSS 22 via a Zh reference point.

In the case that no HSS 22 with the Zh reference point is deployed, the BSF 24 retrieves the AV from either an HLR or an HSS 22 that supports the Zh′ reference point via the Zh′ reference point.

If the BSF 24 implements the timestamp option and has a local copy of the GPRS User Security Settings (GUSS) with a timestamp fetched from the HSS 22 during a previous bootstrapping procedure, the BSF 24 may include the GUSS timestamp in the request message. Upon receiving that timestamp, if the HSS implements the timestamp option, the HSS 22 may compare it with the timestamp of the GUSS stored in the HSS 22. if the timestamps are equal, then the HSS 22 sends “GUSS TIMESTAMP EQUAL” indication to the BSF 24. In any other case, the HSS 22 sends the GUSS (if available) to the BSF 24. If the BSF 24 receives “GUSS TIMESTAMP EQUAL” indication, the BSF 24 reserves the local copy of the GUSS. In any other case, the BSF 24 deletes the local copy of the GUSS, and store the received GUSS (if sent).

In a multiple HSS 22 environment, the BSF 24 may obtain an address of the HSS 22 where a subscription for the UE 20 is stored by querying Subscription Locator Function (SLF).

Step 2202, authentication and authorization information is transmitted. The EEC transmits the authentication and authorization information to the EES. The authentication and authorization information includes a B-TID, an encrypted EEC ID and a key type indicator. The EEC is encrypted with the K_{EES}. The key type indicator is a character string (for example, “Ks_int_NAF”), and is used as a key of the K_{EES}. The EEC may also transmit a GPSI to the EES through a supply request. If the EES authorizes the EEC to access the EES through a service token, the EEC transmits the service token to the EES through the authentication and authorization information. An MAC-I is a message authentication code and is configured to protect integrity of the B-TID, the encrypted EEC ID, the GPSI (if provided), the key type indicator and the service token (if provided by the ECS).

Step 2203, a Zn-Proxy 26 is selected. After receiving the authentication and authorization information, the EES detects the home network of the UE according to the B-TID. If a public land mobile network (PLMN) of the EES is different from a home PLMN of the UE, the EES needs to be connected to the Zn-Proxy in its own PLMN.

Step 2204, the EES 28 transmits an application request. The EES needs to transmit the application request to the Zn-Proxy. The application request includes the B-TID, an NAF ID and a key indicator of the EES.

Step 2205, the Zn-Proxy transmits the application request. The Zn-Proxy transmits the application request to the BSF in the home network of the UE. The application request includes the B-TID, the NAF ID and the key indicator of the EES.

Step 2206, an application makes a response. The BSF derives the K_{EES} according to the B-TID, the NAF ID and the key indicator of the EES. The BSF transmits the KEES and a corresponding expiration time to the Zn-Proxy.

Step 2207, an application makes a response. The Zn-Proxy transmits the K_{EES} and the K_{EES} expiration time to the EES.

Step 2208, integrity is verified. The EES verifies the integrity of the authentication and authorization information by using the key K_{EES} and the MAC-I. If the authentication and authorization information is modified, the EES terminates a supply request process. Otherwise, the EES decrypts the encrypted EEC ID received by the EES.

Step 2209, the K_{EEC-EES} is obtained. After the K_{EES} is received, the EES derives the K_{EEC-EES} according to the K_{EES} and the EEC identifier. The K_{EEC-EES} may be derived using the KDF defined in Appendix B of TS 33.220. The EEC ID is used as the input parameter and the K_{EES} is used as the key for deriving the K_{EEC-EES}.

Step 2210, authentication of the EEC ID and a TLS connection are implemented based on the K_{EEC-EES}. The K_{EEC-EES} is used as a key of the NAF.

Step 2211, the token is verified. The EES authorizes the EEC for a requested service. The EEC authorization is processed based on a pre-configured policy or the token provided by the EEC. In a case of the EEC authorization based on the pre-configured policy, if an EEC registration request message matches the pre-configured policy, the EES authorizes the EEC. In a case of token-based EEC authorization, the EES checks whether the token expires at first. If the token does not expire, the EES verifies a digital signature of the ECS in the token using a public key or a certificate of the ECS. Otherwise, the EES rejects the request. If the digital signature of the ECS in the token passes verification, the EES checks the EEC ID, the GPSI (if provided) and a requested EES service name according to a token declaration. In a case of information matching, the EES authorizes the EEC to access the requested service. Otherwise, the EES rejects the request.

Step 2212, the EES transmits an authorization result through authentication and authorization response information of the EEC.

As shown in FIG. 23, an apparatus 2300 for authenticating and authorizing is provided by this example. The apparatus includes:
a transmission module 231 configured to transmit authentication and authorization information to an edge enabler server (EES); where
the authentication and authorization information is configured to request the EES to authorize an EES service.

It should be noted that those skilled in the art can understand that the method according to the example of the disclosure can be executed separately, or can be executed together with some methods in the examples of the disclosure or some methods in the related art.

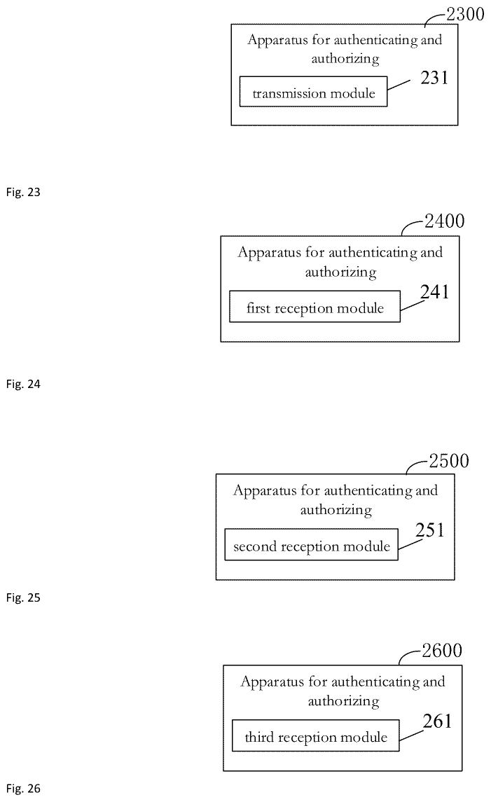

As shown in FIG. 24, another apparatus 2400 for authenticating and authorizing is provided by this example. The apparatus includes:
a first reception module 241 configured to receive authentication and authorization information transmitted by an edge enabler client (EEC); where
the authentication and authorization information is configured to request an EES to authorize an EES service.

It should be noted that those skilled in the art can understand that the method according to the example of the disclosure can be executed separately, or can be executed together with some methods in the examples of the disclosure or some methods in the related art.

As shown in FIG. 25, yet another apparatus 2500 for authenticating and authorizing is provided by this example. The apparatus includes:
a second reception module 251 configured to receive application request information transmitted by an EES; where
the application request information includes at least one of:
a B-TID of the EES;
a network application function (NAF) identifier (ID); or
a key type indicator.

It should be noted that those skilled in the art can understand that the method according to the example of the disclosure can be executed separately, or can be executed together with some methods in the examples of the disclosure or some methods in the related art.

As shown in FIG. 26, still another apparatus 2600 for authenticating and authorizing is provided by this example. The apparatus includes:
a third reception module 261 configured to receive application request information transmitted by a Zn-Proxy; where
the application request information includes at least one of:
a B-TID of an EES;
a network application function (NAF) identifier (ID); or
a key type indicator.

It should be noted that those skilled in the art can understand that the method according to the example of the disclosure can be executed separately, or can be executed together with some methods in the examples of the disclosure or some methods in the related art.

The example of the disclosure provides a communication device. The communication device includes:
a processor; and
a memory configured to store a processor-executable instruction, where
the processor is configured to implement the method according to any example of the disclosure when running the executable instruction.

The processor may include various storage media, and the storage media are non-transitory computer storage media, and may continue storing information stored on the communication device after a power failure of the communication device.

The processor may be connected to the memory through a bus, etc. for reading the executable program stored on the memory.

A non-temporary computer storage medium is further provided by the example of the disclosure. The non-temporary computer storage medium stores a computer-executable program. The executable program implements the method according to any example of the disclosure when performed by a processor.

With respect to the apparatus in the above example, specific ways in which the modules execute operations have been described in detail in the examples relating to the method, and will not be described in detail here.

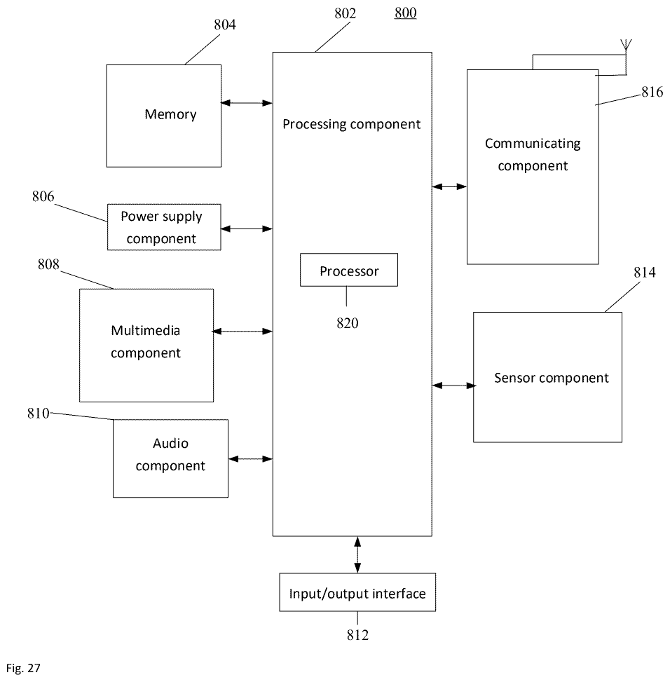

As shown in FIG. 27, a structure of a terminal is shown according to an example of the disclosure.

With reference to FIG. 27, the terminal 800 is shown. The terminal 800 is provided by this example. The terminal may be specifically a mobile phone, a computer, a digital broadcast terminal, a message receiving and transmitting device, a game console, a tablet device, a medical device, a fitness device, a personal digital assistant, etc.

With reference to FIG. 27, the terminal 800 may include one or more of a first processing component 802, a first memory 804, a first power supply component 806, a multimedia component 808, an audio component 810, an first input/output (I/O) interface 812, a sensor component 814, and a communication component 816.

Generally, the first processing component 802 controls an overall operation of the terminal 800, such as an operation associated with display, a telephone call, data communication, a camera operation, and a recording operation. The first processing component 802 may include one or more processors 820 for executing an instruction, and completing all or some steps of the method described above. In addition, the first processing component 802 may include one or more modules for interaction between the first processing component 802 and other components. For example, the first processing component 802 may include a multimedia module for interaction between the multimedia component 808 and the first processing component 802.

The first memory 804 is configured to store various types of data to support the operation by the terminal 800. Instances of these data include instructions, contact data, phone book data, messages, pictures, video, etc. of any application or method operated on the terminal 800. The first memory 804 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The first power supply component 806 energizes various components of the terminal 800. The first power supply component 806 may include a power management system, one or more power supplies, and other components associated with power generation, management, and distribution for the terminal 800.

The multimedia component 808 includes a screen that provides an output interface between the terminal 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and gestures on the touch panel. The touch sensor may not merely sense a boundary of a touch or swipe action, but also measure time of duration and a pressure associated with the touch or swipe action. In some examples, the multimedia component 808 includes a front-facing camera and/or a rear-facing camera. When the terminal 800 is in an operational mode, for example, a photographing mode or a video mode, the front-facing camera and/or the rear-facing camera may receive external multimedia data. Each of the front-facing camera and the rear-facing camera may be a fixed-focus optical lens system or have a focal length and an optical zoom capacity.

The audio component 810 is configured to output and/or input an audio signal. For example, the audio component 810 includes a microphone (MIC). The microphone is configured to receive an external audio signal when the terminal 800 is in an operational mode, such as a call mode, a recording mode or a speech identification mode. The audio signal received may be further stored in the first memory 804 or transmitted through the communication component 816. In some examples, the audio component 810 further includes a speaker configured to output the audio signal.

The first I/O interface 812 provides an interface between the first processing component 802 and a peripheral interface module. The peripheral interface module may be a keyboard, a click wheel, a button, etc. These buttons may include, but are not limited to: a home button, a volume button, a start button and a lock button.

The sensor component 814 includes one or more sensors for providing state assessments in various aspects for the terminal 800. For example, the sensor component 814 may detect an on/off state of the terminal 800, and relative positioning of components. For example, the components are a display and a keypad of the terminal 800. The sensor component 814 may also detect positional change of the terminal 800 or a component of the terminal 800, presence or absence of contact between the user and the terminal 800, orientation or acceleration/deceleration of the terminal 800, and temperature change of the terminal 800. The sensor component 814 may include a proximity sensor configured to detect the presence of a nearby object in the absence of any physical touch. The sensor component 814 may further include an optical sensor, such as a complementary metal-oxide-semiconductor transistor (CMOS) or charge-coupled device (CCD) image sensor for use in an imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the terminal 800 and other devices. The terminal 800 may access a radio network, such as WiFi, 2G or 3G, or their combinations, based on a communication standard. In an example, the communication component 816 receives a broadcast signal or broadcast related information from an external broadcast management system via a broadcast channel. In an example, the communication component 816 further includes a near field communication (NFC) module to promote short-range communications. For example, the NFC module may be implemented based on a radio-frequency identification (RFID) technology, an infrared data association (IrDA) technology, an ultra-wide band (UWB) technology, a Bluetooth (BT) technology, etc.

In an example, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, micro_controllers, micro_processors or other electronic components for executing the method.

In an example, further provided is a non-transitory computer-readable storage medium including an instruction, for example, a first memory 804 including an instruction. The instruction described above may be executed by the processor 820 of the terminal 800, so as to implement the method described above. For example, the non-transitory computer-readable storage medium may be a ROM, a random access memory (RAM), a CD-ROM, a magnetic tape, a floppy disc, an optical data storage device, etc.

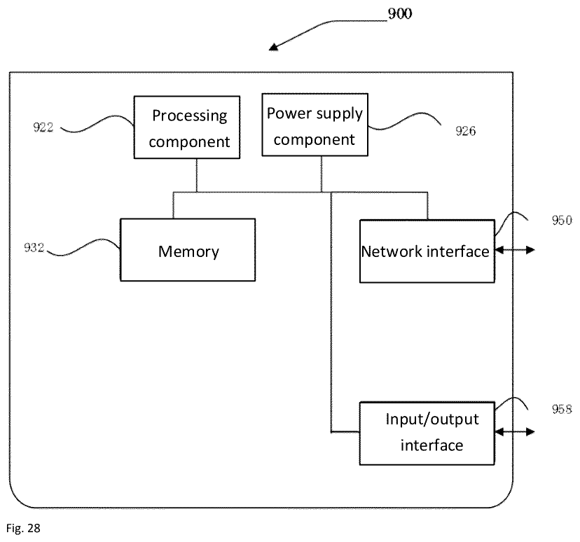

As shown in FIG. 28, a structure of a base station is shown according to an example of the disclosure. For example, the base station 900 may be provided as a network device. With reference to FIG. 28, the base station 900 includes a second processing component 922 and further includes one or more processors, and a memory resource represented by a second memory 932 for storing instructions, such as applications that may be executed by the second processing component 922. The applications stored in the second memory 932 may include one or more modules each corresponding to a set of instructions. In addition, the second processing component 922 is configured to execute instructions to execute any method, applied to the base station, of the foregoing methods.

The base station 900 may further include a second power supply component 926 configured to execute power management of the base station 900, a wired or wireless network interface 950 configured to network the base station 900, and an second input-output (I/O) interface 958. The base station 900 may operate an operating system stored in the second memory 932, such as Windows Server™, Mac OS X™, Unix™, Linux™, FreeBSD™.

Those skilled in the art will readily conceive of other implementation solutions of the disclosure after consideration of the description and implementation of the invention disclosed here. The disclosure is intended to cover any variation, use or adaptive change of the disclosure. The variation, use or adaptive change follows general principles of the disclosure and includes common general knowledge or conventional technical means in the technical art not disclosed in the disclosure. The description and the example are merely considered illustrative, and a true scope and spirit of the disclosure are indicated by the following claims.

It should be understood that the disclosure is not limited to precise structures described above and shown in the accompanying drawings, and various modifications and changes can be made without departing from the scope of the disclosure. The scope of the disclosure is merely limited by the appended claims.

1. A method for authenticating and authorizing, wherein the method is performed by an edge enabler client (EEC), the method comprising:
sending authentication and authorization information to an edge enabler server (EES);
wherein the authentication and authorization information is configured to request the EES to authorize an EES service.

2. The method according to claim 1, wherein the method further comprises:
receiving authentication and authorization response information sent by the EES;
wherein the authentication and authorization response information indicates that the EES authorizes the EES service requested by the EEC or rejects the EES service requested by the EEC.

3. The method according to claim 1, wherein the authentication and authorization information comprises at least one of:
a bootstrapping transaction identifier (B-TID);
an encrypted EEC identifier (ID);
a key type indicator;
a generic public subscription identifier (GPSI);
a message authentication code; or
a service token.

4. (canceled)

5. The method according to claim 3, wherein the message authentication code is a message authentication code MAC-I determined based on KEES, and is configured to protect integrity of the B-TID, the encrypted EEC ID, the GPSI and/or the key type indicator.

6. The method according to claim 3, wherein the encrypted EEC ID is encrypted based on a key KEES.

7. The method according to claim 1, wherein the method further comprises:
obtaining a B-TID from a bootstrapping server function (BSF) of a home network during running of a generic bootstrapping architecture (GBA).

8. The method according to claim 1, wherein the method further comprises:
determining a key KEEC-EES based on a key KEES and an EEC identifier (ID);
wherein the key KEEC-EES is configured to execute mutual identity authentication and/or establishment of a transport layer security (TLS) connection between the EEC and the EES.

9. (canceled)

10. A method for authenticating and authorizing, wherein the method is performed by an edge enabler server (EES), the method comprising:
receiving authentication and authorization information sent by an edge enabler client (EEC);
wherein the authentication and authorization information is configured to request the EES to authorize an EES service.

11-13. (canceled)

14. The method according to claim 10, wherein the method further comprises:
determining a network to which the EES is connected in response to receiving the authentication and authorization information;
establishing a connection to a network to which the EES is connected, in response to determining that an identifier of the network to which the EES is connected is identical to an identifier of a public land mobile network of the EEC that is configured to establish a connection to the EES, and the identifier of the public land mobile network of the EEC that is configured to establish a connection to the EES is different from a home network identifier of the EEC.

15. (canceled)

16. The method according to claim 4, wherein the method further comprises:
obtaining the identifier and/or an access type of the public land mobile network of the EEC that is configured to establish a connection to the EES from a policy control function (PCF).

17. The method according to claim 4, wherein the method further comprises:
determining the home network identifier of the EEC based on a B-TID.

18. The method according to claim 14, wherein the method further comprises:
sending application request information to a Zn-Proxy in the network connected to the EES;
wherein the application request information comprises at least one of:
a B-TID of the EEC;
a network application function (NAF) identifier (ID) (NAF-ID); or
a key type indicator.

19. The method according to claim 18, wherein the method further comprises:
receiving application authentication and authorization response information sent by the Zn-Proxy, wherein the application authentication and authorization response information comprises a key KEES and/or effective time information of the key KEES;
and/or,
verifying integrity of the authentication and authorization information based on the key KEES and/or an MAC-I.

20. (canceled)

21. The method according to claim 19, wherein the method further comprises:
terminating an authentication and authorization process, in response to determining that the authentication and authorization information is modified; and alternatively,
decrypting an encrypted EEC ID received by the EES, in response to determining that the authentication and authorization information is not modified.

22-23. (canceled)

24. The method according to claim 2319, wherein the method further comprises:
authorizing the EES service requested by the EEC, in response to determining that the authentication and authorization information matches the pre-configured policy;
and/or,
checking whether the service token expires, verifying a digital signature of an ECS in the token by using a public key or a certificate of the ECS, in response to determining that the service token does not expire; and alternatively, rejecting the authentication and authorization information, in response to determining that the server token expires.

25. The method according to claim 24, wherein the service token comprises at least one of:
a fully qualified domain name (FQDN) of an edge configuration server (ECS);
the EEC identifier (ID);
a GPSI;
an expected EES service name;
an FQDN of the EES;
effective time; or
a digital signature.

26-30. (canceled)

31. A method for authenticating and authorizing, comprising:
receiving application request information sent by an EES by a Zn interface proxy Zn-Proxy;
wherein the application request information comprises at least one of:
a B-TID of the EES;
a network application function (NAF) identifier (ID); or
a key type indicator.

32-34. (canceled)

35. The method according to claim 31, wherein the method further comprises:
receiving the application request information sent by the Zn-Proxy by a bootstrapping server function (BSF);
a B TID of an EES;
determining a key KEES based on the application request information, and sending application response information to the Zn-Proxy by the BSF, wherein the application response information comprises the key KEES and/or effective time information of the key KEES.

36-41. (canceled)

42. A communication device, comprising:
a memory; and
a processor connected to the memory, and configured to be capable of implementing the method according to claim 1 by executing a computer-executable instruction stored in the memory.

43. A non-temporary computer storage medium, storing a computer-executable instruction, wherein the computer-executable instruction is capable of implementing the method according to claim 1 after being executed by a processor.
